(19) United States
(12) Patent Application Publication
(10) Pub. No.: US 2022/0163387 A1
(43) Pub. Date: May 26, 2022

(54) METHOD FOR OPTIMIZING OUTPUT RESULT OF SPECTROMETER AND ELECTRONIC DEVICE USING THE SAME

(71) Applicant: Coretronic Corporation, Hsin-Chu (TW)

(72) Inventors: Feng Wang, Hsin-Chu (TW); Yen-Chun Huang, Hsin-Chu (TW); Kui-Ting Chen, Hsin-Chu (TW)

(73) Assignee: Coretronic Corporation, Hsin-Chu (TW)

(21) Appl. No.: 17/533,116

(22) Filed: Nov. 23, 2021

(30) Foreign Application Priority Data
Nov. 26, 2020 (TW) 109141520

(51) Int. Cl. G01J 3/28; G06K 9/62; G06N 20/00

(52) U.S. Cl. CPC G01J 3/28; G06K 9/6227; G01J 2003/2836; G01J 2003/284; G06N 20/00

(57) ABSTRACT

A method for optimizing an output result of a spectrometer and an electronic device using the method are provided. The method includes the following. First spectral data and second spectral data are obtained. A plurality of pipelines including a first pipeline and a second pipeline are obtained. The first pipeline is selected from the plurality of pipelines as a selected pipeline. The output result corresponding to the second spectral data is generated according to the selected pipeline. A performance of the first pipeline is calculated according to the first spectral data, and a first instruction is generated according to the performance. The selected pipeline is changed into the second pipeline according to the first instruction to update the output result.

### CROSS-REFERENCE TO RELATED APPLICATION

This application claims the priority benefit of Taiwan application serial no. 109141520, filed on Nov. 26, 2020. The entirety of the above-mentioned patent application is hereby incorporated by reference herein and made a part of this specification.

### BACKGROUND

### Technical Field

The disclosure is about a method for automatically optimizing the output result of the spectrometer and the electronic device using the method.

### Description of Related Art

Applications of a spectrometer rely on quality of recognition models (calibration curve models) configured to detect spectral features, and different applications correspond to different spectral features. Therefore, each of the applications of the spectrometer requires establishment of the corresponding recognition model by an expert. The expert requires repetitive trials on a variety of combinations of pre-processing models, machine learning models, and hyperparameters to generate a suitable recognition model, and the generated recognition model is not necessarily the best.

At present, manners for generating a recognition model for detecting spectral features lack a means for users to intervene and timely adjust parameters of the recognition model. If a user is not satisfied with the performance of the recognition model, the user requires to manually re-select one or more algorithms among a great number of algorithms to train the recognition model. The above approach consumes a great amount of time of the user.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY

The disclosure provides a method for automatically optimizing an output result of a spectrometer and an electronic device using the method, which automatically select an algorithm to establish an optimal recognition model, and also allow a user to correct the trained recognition model by interacting with a graphical interface.

In the disclosure, an electronic device for automatically optimizing an output result of a spectrometer includes a processor, a storage medium, and a transceiver. The transceiver obtains first spectral data and second spectral data. The storage medium stores a plurality of modules. The processor is coupled to the storage medium and the transceiver, and accesses and executes the plurality of modules, including a pipeline recommendation module and a performance evaluation module. The pipeline recommendation module stores a plurality of pipelines including a first pipeline and a second pipeline. The pipeline recommendation module selects the first pipeline from the plurality of pipelines as a selected pipeline, and generates the output result corresponding to the second spectral data according to the selected pipeline. The performance evaluation module calculates a performance of the first pipeline according to the first spectral data, and transmits a first instruction to the pipeline recommendation module according to the performance. The pipeline recommendation module changes the selected pipeline into the second pipeline according to the first instruction to update the output result.

In an embodiment of the disclosure, the plurality of modules further include a graphic generation module. The graphic generation module outputs the output result through the transceiver, and, in response to a change of the selected pipeline, outputs the output result that is updated. The output result includes a spectral line corresponding to the second spectral data.

In an embodiment of the disclosure, the plurality of modules further include an outlier detection module. The outlier detection module, receives a second instruction through the transceiver in response to the graphic generation module outputting the output result, determines an outlier in the second spectral data according to the second instruction, and deletes the outlier from the second spectral data.

In an embodiment of the disclosure, the plurality of modules further include an outlier detection module. The outlier detection module projects the second spectral data onto a two-dimensional plane to generate two-dimensional spectral data, and determines an outlier in the second spectral data according to the two-dimensional spectral data.

In an embodiment of the disclosure, the outlier detection module determines the outlier according to the second spectral data based on one of a local outlier factor algorithm and an isolation forest algorithm.

In an embodiment of the disclosure, the outlier detection module projects the second spectral data onto the two-dimensional plane based on one of t-distributed stochastic neighbor embedding and principal components analysis.

In an embodiment of the disclosure, the first pipeline includes a combination of at least one pre-processing program and a machine learning model.

In an embodiment of the disclosure, the pipeline recommendation module trains a recognition model according to the first spectral data and the first pipeline, and the performance evaluation module calculates the performance according to the recognition model and the first spectral data.

In an embodiment of the disclosure, the pipeline recommendation module trains the recognition model according to a first loss function, and the performance evaluation module calculates the performance according to a second loss function. The first loss function and the second loss function are related to a mean squared error algorithm.

In an embodiment of the disclosure, the performance evaluation module transmits the first instruction to the pipeline recommendation module in response to the performance being lower than a threshold.

In the disclosure, a method for automatically optimizing an output result of a spectrometer includes the following. First spectral data and second spectral data are obtained. A plurality of pipelines including a first pipeline and a second pipeline are obtained. The first pipeline is selected from the plurality of pipelines as a selected pipeline. The output result corresponding to the second spectral data is generated according to the selected pipeline. A performance of the first pipeline is calculated according to the first spectral data, and a first instruction is generated according to the performance. The selected pipeline is changed into the second pipeline according to the first instruction to update the output result.

In an embodiment of the disclosure, the method further includes the following. An output result is output, and, in response to a change of the selected pipeline, the output result that is updated is output. The output result includes a spectral line corresponding to the second spectral data.

In an embodiment of the disclosure, the method further includes the following. A second instruction is received in response to the outputting the output result, an outlier in the second spectral data according to the second instruction is determined, and the outlier from the second spectral data is deleted.

In an embodiment of the disclosure, the method further includes the following. The second spectral data is projected onto a two-dimensional plane to generate two-dimensional spectral data, and an outlier is determine in the second spectral data according to the two-dimensional spectral data.

In an embodiment of the disclosure, the step of determining the outlier in the second spectral data according to the two-dimensional spectral data includes the following. The outlier is determined according to the second spectral data based on one of a local outlier factor algorithm and an isolation forest algorithm.

In an embodiment of the disclosure, the step of projecting the second spectral data onto the two-dimensional plane to generate the two-dimensional spectral data includes the following. The second spectral data is projected onto the two-dimensional plane based on one of t-distributed stochastic neighbor embedding and principal components analysis.

In an embodiment of the disclosure, the first pipeline includes a combination of at least one pre-processing program and a machine learning model.

In an embodiment of the disclosure, the step of calculating the performance of the first pipeline according to the first spectral data includes the following. A recognition model is trained according to the first spectral data and the first pipeline, and the performance is calculated according to the recognition model and the first spectral data.

In an embodiment of the disclosure, the step of training the recognition model according to the first spectral data and the first pipeline includes the following. The recognition model is trained according to a first loss function. In addition, the step of calculating the performance according to the recognition model and the first spectral data includes the following. The performance is calculated according to a second loss function. Herein, the first loss function and the second loss function are related to a mean squared error algorithm.

In an embodiment of the disclosure, the step of generating the first instruction according to the performance includes the following. The first instruction is generated in response to the performance being lower than a threshold.

Based on the foregoing, in the disclosure, the method for automatically optimizing the output result of the spectrometer and the electronic device using the method efficiently generate the recognition model for detecting spectral data, and provide the user with a simple way to manually correct the trained recognition model.

Other objectives, features and advantages of the present invention will be further understood from the further technological features disclosed by the embodiments of the present invention wherein there are shown and described preferred embodiments of this invention, simply by way of illustration of modes best suited to carry out the invention.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing an electronic device for automatically optimizing an output result of a spectrometer according to an embodiment of the disclosure.

FIG. 2 is a schematic diagram showing the spectral line of the second spectral data according to an embodiment of the disclosure.

FIG. 3 is a distribution histogram showing spectral data according to an embodiment of the disclosure.

FIG. 4 is a schematic diagram showing two-dimensional spectral data and a spectral line according to an embodiment of the disclosure.

FIG. 5 is a schematic diagram showing two-dimensional spectral data according to an embodiment of the disclosure.

FIG. 6 is a flowchart showing a method for automatically optimizing an output result of a spectrometer according to an embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

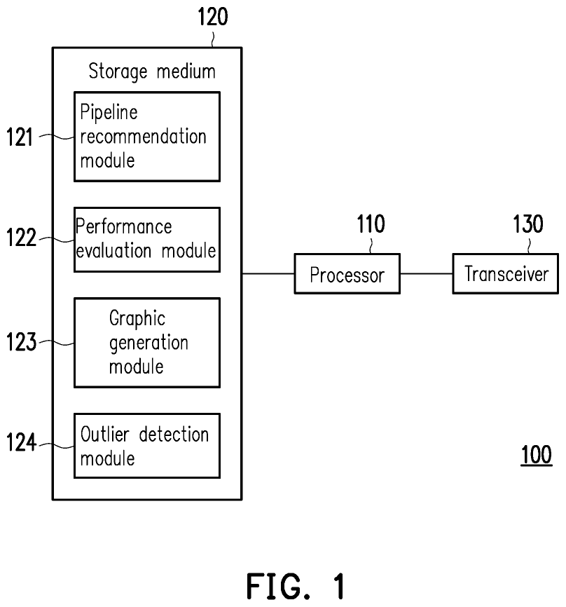

FIG. 1 is a schematic diagram showing an electronic device 100 for automatically optimizing an output result of a spectrometer according to an embodiment of the disclosure. The electronic device 100 may include a processor 110, a storage medium 120, and a transceiver 130.

The processor 110 includes, for example, a central processing unit (CPU), or any other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), other similar elements, or a combination of the above elements. The processor 110 may be coupled to the storage medium 120 and the transceiver 130, and access and execute a plurality of modules and various applications stored in the storage medium 120.

The storage medium 120 includes, for example, a fixed or removable element in any form, such as a random access memory (RAM) device, a read only memory (ROM) device, a flash memory device, a traditional hard disk drive (HDD), a solid-state drive (SSD), similar elements, or a combination of the above elements, and is configured to store the modules or various applications that can be executed by the processor 110. In this embodiment, the storage medium 120 may store the modules including a pipeline recommendation module 121, a performance evaluation module 122, a graphic generation module 123, and an outlier detection module 124, each represents one or more sets of codes that independently execute a specific algorithm, to be provided to the processor 110 for accessing and performing specific operations, for example but not limited to, pipeline recommendation, performance evaluation, graphic generation, and outlier detection. The function thereof will be further explained later.

The transceiver 130 transmits and receives signals in a wireless or wired manner. The transceiver 130 may also perform operations such as low noise amplification, impedance matching, frequency mixing, frequency up-conversion or down-conversion, filtering, amplification, and the like. The transceiver 130 may receive, for example, spectral data from a spectrometer, or receive an instruction input from an external input device (e.g., a keyboard or a touch screen). On the other hand, the transceiver 130 may output the output result generated by the electronic device 100 (e.g., information representing a graphic of a spectral line) to an external display, and the output result may be displayed by the external display. The external display includes, for example, a projector or a liquid crystal display.

The graphic generation module 123 may output information or data related to the output result or/and a selected pipeline and a corresponding performance thereof to the external display through the transceiver 130 to display graphics and information. The operation thereof will be further explained later.

The transceiver 130 may obtain first spectral data for training a recognition model of the spectrometer. The first spectral data includes, for example, label data. The pipeline recommendation module 121 may train the recognition model according to the first spectral data. Specifically, the storage medium 120 may store a plurality of pipelines, where a pipeline is an independent executable workflow in a complete machine learning work, and the workflow may include multiple steps or programs. In this embodiment, each of the pipelines may include a combination of at least one pre-processing program, and the at least one pre-processing program may be related to, for example, a smooth program, wavelet program, baseline correction program, differentiation program, standardization program, or random forest (RF) program, and the disclosure is not limited thereto. Besides, each of the pipelines may also include a machine learning model, where the machine learning model may include a regression model or a classification model, and the disclosure is not limited thereto.

The pipeline recommendation module 121 may select a selected pipeline from the pipelines stored in the storage medium 120. Specifically, the pipeline recommendation module 121 may use automated machine learning (AutoML) to select at least one pre-processing program and a machine learning model to form a pipeline that may serve as the selected pipeline. After obtaining the selected pipeline, the pipeline recommendation module 121 may train a recognition model corresponding to the selected pipeline according to the selected pipeline and the first spectral data, namely train the selected pipeline with the first spectral data to obtain the recognition model corresponding to the selected pipeline. Specifically, the pipeline recommendation module 121 may divide the first spectral data into a training set, a verification set, and a test set. The pipeline recommendation module 121 may use the training set to train the recognition model of the selected pipeline. A loss function used when training the recognition model may be related to a mean squared error algorithm, but the disclosure is not limited thereto. Then, the pipeline recommendation module 121 may use the verification set to adjust and optimize a hyperparameter of the recognition model.

After adjusting the hyperparameter of the recognition model, the performance evaluation module 122 may calculate a performance of the selected pipeline according to the recognition model and the first spectral data. Specifically, the performance evaluation module 122 may use the test set and the loss function to determine the performance of the selected pipeline and the recognition model corresponding to the selected pipeline, and the loss function used in determining the performance may be related to a mean squared error algorithm, but the disclosure is not limited thereto. After calculating the performance, the performance evaluation module 122 may output the information related to the selected pipeline and the corresponding performance thereof through the transceiver 130. For example, the performance evaluation module 122 may output the information related to the selected pipeline and the corresponding performance thereof sequentially through the graphic generation module 123 and the transceiver 130 to the external display, so that the external display may display the related information to the user. According to the related information, the user may determine whether the performance of the selected pipeline meets the expectation to set a first instruction.

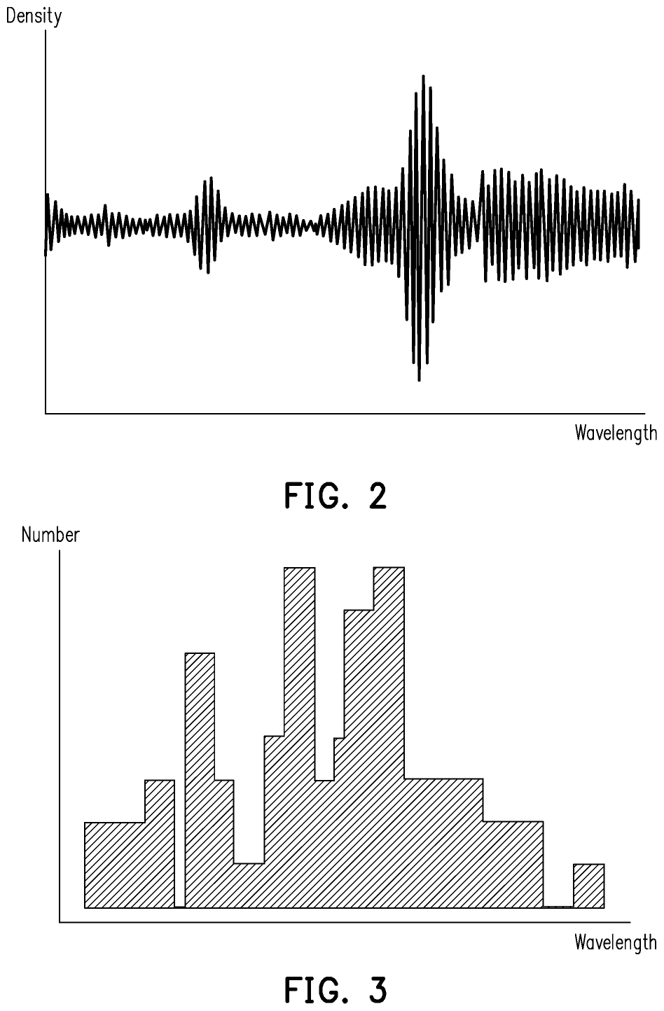

On the other hand, after generating the recognition model of the selected pipeline, the pipeline recommendation module 121 may use the recognition model to generate an output result. Specifically, the transceiver 130 may obtain second spectral data. The pipeline recommendation module 121 may use the recognition model corresponding to the selected pipeline to process the second spectral data in order to generate the output result corresponding to the second spectral data. In an embodiment, the output result may include a spectral line of the second spectral data, as shown in FIG. 2. FIG. 2 is a schematic diagram showing the spectral line of the second spectral data according to an embodiment of the disclosure. The spectral line represents a density of the second spectral data at different wavelengths. In another embodiment, the output result may include a distribution histogram of the second spectral data, as shown in FIG. 3. FIG. 3 is a distribution histogram showing spectral data according to an embodiment of the disclosure. The distribution histogram represents the number of samples of the second spectral data at different wavelengths.

The spectral line of the second spectral data is, for example, a standard normal variate (SNV) curve generated by the pipeline recommendation module 121 according to the second spectral data, but the disclosure is not limited thereto. After the output result corresponding to the second spectral data is generated or updated (e.g., the second spectral data being updated caused by switching the selected pipeline), the graphic generation module 123 may output the output result through the transceiver 130 to the external display for displaying. Therefore, the user may determine the influence of the currently adopted pre-processing model, machine learning model, or hyperparameter on the spectral line according to the spectral line displayed on the external display.

In an embodiment, the user may instruct the electronic device 100 to re-select the selected pipeline. Specifically, the user may send an instruction to the electronic device 100 through the external input device. After the transceiver 130 receives the instruction, according to the instruction, the pipeline recommendation module 121 may select another pipeline different from the current selected pipeline from the pipelines stored in the storage medium 120 as a new selected pipeline.

In an embodiment, the electronic device 100 may automatically re-select the selected pipeline. Specifically, after the performance evaluation module 122 calculates the performance corresponding to the selected pipeline, the performance evaluation module 122 may transmit an instruction to the pipeline recommendation module 121 according to the performance, to thereby instruct the pipeline recommendation module 121 to re-select the selected pipeline. For example, the storage medium 120 may store a threshold in advance, and the threshold may be set by the user. The performance evaluation module 122 may transmit the first instruction to the pipeline recommendation module 121 in response to the performance being lower than the threshold, to thereby instruct the pipeline recommendation module 121 to select another pipeline different from the current selected pipeline from the pipelines stored in the storage medium 120 as a new selected pipeline.

After the pipeline recommendation module 121 re-selects the selected pipeline, the pipeline recommendation module 121 may train the recognition model that is updated according to the selected pipeline that is updated, and update the output result corresponding to the second spectral data according to the recognition model that is updated.

The outlier detection module 124 may project the second spectral data onto a two-dimensional plane to generate two-dimensional spectral data. For example, the outlier detection module 124 may project the second spectral data onto the two-dimensional plane based on t-distributed stochastic neighbor embedding (t-SNE) or principal components analysis (PCA). Accordingly, the outlier detection module 124 may represent high-dimensional data in low-dimensional graphics to provide the user with a visual and intuitive verification of the validity of the two-dimensional spectral data.

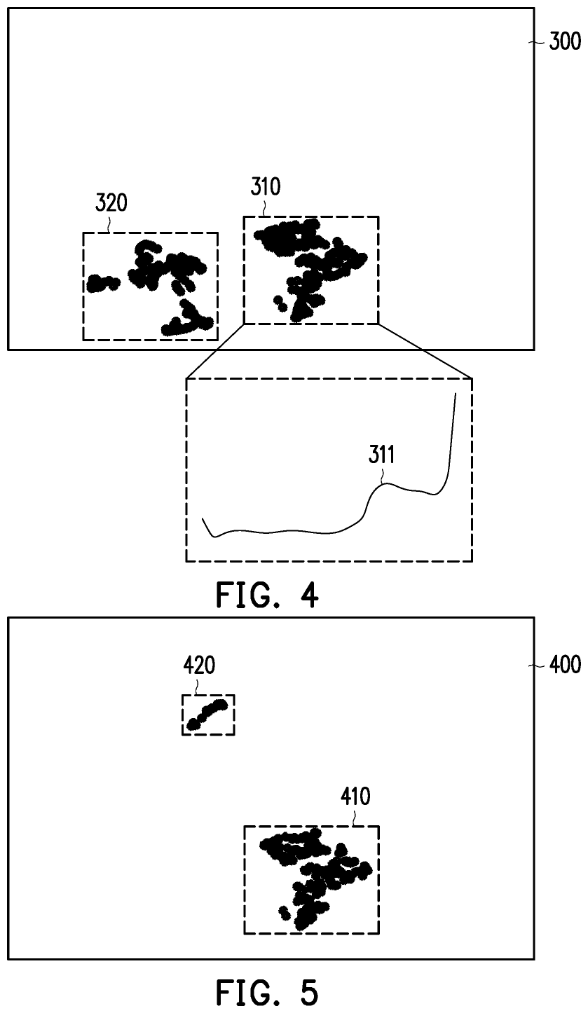

FIG. 4 is a schematic diagram showing two-dimensional spectral data 300 and a spectral line 311 according to an embodiment of the disclosure, where a two-dimensional plane is exemplarily represented by a plane formed of a vertical axis and a horizontal axis. After observing the two-dimensional spectral data 300, the user may easily determine that the two-dimensional spectral data 300 may include a cluster 310 and a cluster 320, and the spectral line 311 is a spectral line corresponding to the cluster 310. According to the different clusters included in the two-dimensional spectral data 300, the user may determine that the second spectral data is possibly affected by an external factor. For example, it may be assumed that the user uses a first machine and a second machine to produce the same products, and measure the second spectral data of the products through the spectrometer. According to the two-dimensional spectral data 300 of the second spectral data, the user may determine that the second spectral data includes spectral data of the products manufactured by different machines. For example, the cluster 310 may correspond to the product manufactured by the first machine, and the cluster 320 may correspond to the product manufactured by the second machine.

In an embodiment, the outlier detection module 124 may transmit the two-dimensional spectral data to an external display through the transceiver 130, to thereby display the two-dimensional spectral data through the external display for the user to view. According to two-dimensional spectral data, the user may determine an outlier in the second spectral data. FIG. 5 is a schematic diagram showing two-dimensional spectral data 400 according to an embodiment of the disclosure. The outlier detection module 124 may project the second spectral data onto a two-dimensional plane to generate the two-dimensional spectral data 400. The two-dimensional spectral data 400 may include a cluster 410 and a cluster 420.

The outlier detection module 124 may display different clusters in different colors. According to the two-dimensional spectral data 400, the user may determine that the second spectral data includes an outlier corresponding to the cluster 420. The user may send the second instruction to the electronic device 100 through an external input device. After the transceiver 130 receives the second instruction, the outlier detection module 124 may determine the outlier in the second spectral data according to the second instruction, and delete the outlier from the second spectral data. After the outlier of the second spectral data is deleted and the second spectral data that is updated is generated, the pipeline recommendation module 121 may use the recognition model to process the second spectral data that is updated to generate the output result that is updated.

In an embodiment, the outlier detection module 124 may determine the outlier in the second spectral data according to the two-dimensional spectral data. For example, the outlier detection module 124 may determine the outlier according to the second spectral data based on a local outlier factor algorithm or an isolation forest algorithm.

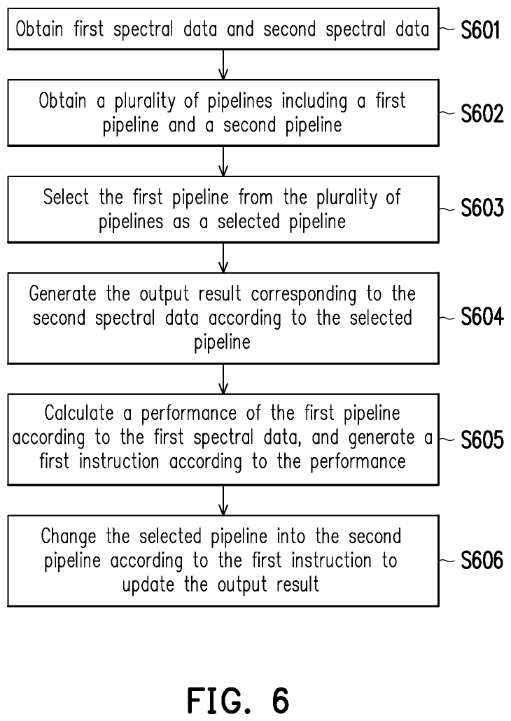

FIG. 6 is a flowchart showing a method for automatically optimizing an output result of a spectrometer according to an embodiment of the disclosure, and the method may be implemented by the electronic device 100 as shown in FIG. 1. Firstly, the processor 110 performs the following step through the transceiver 130. In step S601, first spectral data and second spectral data are obtained. Next, the processor 110 executes the pipeline recommendation module 121 through the storage medium 120 to perform the following steps. In step S602, a plurality of pipelines including a first pipeline and a second pipeline are obtained. In step S603, the first pipeline is selected from the pipelines as a selected pipeline. In step S604, an output result corresponding to the second spectral data is generated according to the selected pipeline. Then, the processor 110 executes the performance evaluation module 122 through the storage medium 120 to perform the following step. In step S605, a performance of the first pipeline (i.e., the selected pipeline) is calculated according to the first spectral data, and a first instruction is generated according to the performance. Also, the processor 110 executes the pipeline recommendation module 121 through the storage medium 120 to perform the following step. In step S606, the selected pipeline is changed into the second pipeline according to the first instruction to update the output result. In this embodiment, step S604 and step S605 may be performed at the same time or sequentially in either sequence.

In summary of the foregoing, the disclosure may automatically select the optimal combination for specific spectral features among a great number of combinations of pre-processing algorithms, machine learning algorithms, and hyperparameters, to generate the recognition model for detecting the specific spectral features. The expert no longer requires to individually establish a corresponding recognition model for each of the different spectral features. Besides, the disclosure instantly outputs the graphic of the spectral line corresponding to the spectral data. The user may observe the influence of the currently used recognition model on the spectral line through the graphic. On the other hand, the disclosure projects different spectral data onto a two-dimensional plane to generate two-dimensional spectral data. The user may easily observe the outlier in the spectral data from the two-dimensional spectral data. The user may determine whether the observed spectral data is affected by an external factor through the outlier. For example, through the outlier, the user may determine whether a difference is present between the spectral lines of the products manufactured by different apparatuses.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An electronic device for automatically optimizing an output result of a spectrometer, comprising:
a transceiver obtaining first spectral data and second spectral data;
a storage medium storing a plurality of modules; and
a processor coupled to the storage medium and the transceiver, and accessing and executing the plurality of modules, wherein the plurality of modules comprise:
a pipeline recommendation module storing a plurality of pipelines comprising a first pipeline and a second pipeline, wherein the pipeline recommendation module selects the first pipeline from the plurality of pipelines as a selected pipeline, and generates the output result corresponding to the second spectral data according to the selected pipeline; and
a performance evaluation module, calculating a performance of the first pipeline according to the first spectral data, and transmitting a first instruction to the pipeline recommendation module according to the performance of the first pipeline, wherein
the pipeline recommendation module changes the selected pipeline into the second pipeline according to the first instruction to update the output result.

2. The electronic device according to claim 1, wherein the plurality of modules further comprise:
a graphic generation module outputting the output result through the transceiver, and, in response to a change of the selected pipeline, outputting the output result that is updated, wherein the output result comprises a spectral line corresponding to the second spectral data.

3. The electronic device according to claim 2, wherein the plurality of modules further comprise:
an outlier detection module receiving a second instruction through the transceiver in response to the graphic generation module outputting the output result, determining an outlier in the second spectral data according to the second instruction, and deleting the outlier from the second spectral data.

4. The electronic device according to claim 1, wherein the plurality of modules further comprise:
an outlier detection module projecting the second spectral data onto a two-dimensional plane to generate two-dimensional spectral data, and determining an outlier in the second spectral data according to the two-dimensional spectral data.

5. The electronic device according to claim 4, wherein the outlier detection module determines the outlier according to the second spectral data based on one of a local outlier factor algorithm and an isolation forest algorithm.

6. The electronic device according to claim 4, wherein the outlier detection module projects the second spectral data onto the two-dimensional plane based on one of t-distributed stochastic neighbor embedding and principal components analysis.

7. The electronic device according to claim 1, wherein the first pipeline comprises a combination of at least one pre-processing program and a machine learning model.

8. The electronic device according to claim 7, wherein the pipeline recommendation module trains a recognition model according to the first spectral data and the first pipeline, and the performance evaluation module calculates the performance according to the recognition model and the first spectral data.

9. The electronic device according to claim 8, wherein the pipeline recommendation module trains the recognition model according to a first loss function, and the performance evaluation module calculates the performance according to a second loss function, wherein the first loss function and the second loss function are related to a mean squared error algorithm.

10. The electronic device according to claim 1, wherein the performance evaluation module, transmits the first instruction to the pipeline recommendation module in response to the performance being lower than a threshold.

11. A method for automatically optimizing an output result of a spectrometer, wherein the method comprises:
obtaining first spectral data and second spectral data;
obtaining a plurality of pipelines comprising a first pipeline and a second pipeline;
selecting the first pipeline from the plurality of pipelines as a selected pipeline;
generating the output result corresponding to the second spectral data according to the selected pipeline;
calculating a performance of the first pipeline according to the first spectral data, and generating a first instruction according to the performance; and
changing the selected pipeline into the second pipeline according to the first instruction to update the output result.

12. The method according to claim 11, further comprising:
outputting the output result, and, in response to a change of the selected pipeline, outputting the output result that is updated, wherein the output result comprises a spectral line corresponding to the second spectral data.

13. The method according to claim 12, further comprising:
receiving a second instruction in response to the outputting the output result;
determining an outlier in the second spectral data according to the second instruction; and
deleting the outlier from the second spectral data.

14. The method according to claim 11, further comprising:
projecting the second spectral data onto a two-dimensional plane to generate two-dimensional spectral data; and
determining an outlier in the second spectral data according to the two-dimensional spectral data.

15. The method according to claim 14, wherein the step of determining the outlier in the second spectral data according to the two-dimensional spectral data comprises:
determining the outlier according to the second spectral data based on one of a local outlier factor algorithm and an isolation forest algorithm.

16. The method according to claim 14, wherein the step of projecting the second spectral data onto the two-dimensional plane to generate the two-dimensional spectral data comprises:
projecting the second spectral data onto the two-dimensional plane based on one of t-distributed stochastic neighbor embedding and principal components analysis.

17. The method according to claim 11, wherein the first pipeline comprises a combination of at least one pre-processing program and a machine learning model.

18. The method according to claim 17, wherein the step of calculating the performance of the first pipeline according to the first spectral data comprises:
training a recognition model according to the first spectral data and the first pipeline; and
calculating the performance according to the recognition model and the first spectral data.

19. The method according to claim 18, wherein the step of training the recognition model according to the first spectral data and the first pipeline comprises training the recognition model according to a first loss function; and
the step of calculating the performance according to the recognition model and the first spectral data comprises calculating the performance according to a second loss function,
wherein the first loss function and the second loss function are related to a mean squared error algorithm.

20. The method according to claim 11, wherein the step of generating the first instruction according to the performance comprises:
generating the first instruction in response to the performance being lower than a threshold.
